(19) United States
(12) Patent Application Publication
(10) Pub. No.: US 2005/0119879 A1
(43) Pub. Date: Jun. 2, 2005

(54) Method and apparatus to compensate for imperfections in sound field using peak and dip frequencies

(76) Inventors: Ho-young Sung, Suwon-si (KR); Sang-il Park, Seoul (KR)

Correspondence Address: STANZIONE & KIM, LLP, 1740 N STREET, N.W., FIRST FLOOR, WASHINGTON, DC, 20036, US

(21) Appl. No.: 10/997,966

(22) Filed: Nov. 29, 2004

(30) Foreign Application Priority Data
Dec. 2, 2003 (KR) 2003-86752

(51) Int. Cl. G10L 19/14

(52) U.S. Cl. 704/205

(57) ABSTRACT

A method and apparatus to compensate for imperfections in a sound field includes determining a frequency-response characteristic of a test signal, extracting a difference spectrum by filtering the frequency-response characteristic on different octave band scales, detecting frequency parameters of peak and dip components that deviate from a critical value in the difference spectrum, and calculating filter coefficients from the frequency parameters to filter an input audio signal.

### CROSS-REFERENCE TO RELATED APPLICATIONS

This application claims the priority of Korean Patent Application No. 2003-86752, filed on Dec. 2, 2003, in the Korean Intellectual Property Office, the disclosure of which is incorporated herein in its entirety by reference.

### BACKGROUND OF THE INVENTION

1. Field of the Invention

The present general inventive concept relates to an audio system, and more particularly, to a method and apparatus to compensate for imperfections in a sound field using peak and dip components.

2. Description of the Related Art

Generally, in compensating for imperfections in a frequency characteristic, a filtering range of a compensation filter falls within an audible range. However, if an audio signal is filtered using a limited resource, compensation performance of components of a system deteriorates when distortion of the audio signal is severe although the components have been improved.

A conventional method of compensating for imperfections in a sound field of an audio system is shown in Korean patent publication No.: 10-200047624, titled “Automatic Loud Speaker Equalizer.”

FIG. 1 is a block diagram illustrating a conventional apparatus for compensating for imperfections in a sound field.

Referring to FIG. 1, the apparatus includes a microphone 110, a sound field measurement unit 120 to measure a response characteristic of converted sounds, an automatic loudspeaker equalizer 140 to compensate for the response characteristic measured by the sound field measurement unit 120, a filtering unit 130 to filter an input audio signal with an equalization coefficient generated by the automatic loudspeaker equalizer 140 and to send the filtered audio signal to a speaker 150.

A method of the automatic loudspeaker equalizer 140 to perform sound equalization will now be described. The automatic loudspeaker equalizer 140 contains built-in target curve data. The target curve data is a frequency-response characteristic curve, which is flat over the entire frequency range. The automatic loudspeaker equalizer 140 compares a measured frequencyresponse characteristic curve with a target curve to detect peak frequencies (or components) having levels (amplitude) greater than or equal to a maximum level of a target curve. A peak frequency having a greatest level of the detected peak frequencies is chosen, and its quality factor Q and center frequency fc are measured, so that a filter for compensating for the chosen peak frequency is made. After this, another peak frequency having another greatest level among the remaining peak frequencies is searched, so that another filter is made to compensate for the searched peak frequency. In this way, more filters are made for other peak frequencies, and the filtering unit 130 can be implemented with a number of such filters.

In the conventional apparatus, the peak frequencies are chosen from among frequencies having levels greater than or equal to a predetermined level of the target curve, in order of level or amplitude. However, according to a psycho acoustic model, the extent to which a human recognizes a peak frequency within a specific frequency band depends on the frequency and the Q factor. Therefore, a conventional compensation filter may happen to compensate for a peak frequency that the human cannot recognize. In addition, in the apparatus of FIG. 1, a level-deteriorating frequency, such as a dip frequency, is not considered for compensation at all. Further, an algorithm that optimizes a compensating performance of a filter becomes very complicated in that the algorithm should change a bandwidth and perform a lot of logarithmic and integral calculations. The algorithm also should be repeated as many times as the number of filters, thereby imposing a great burden on a system.

### SUMMARY OF THE INVENTION

The present general inventive concept provides a method of and apparatus to compensate for imperfections of a sound field in an acoustic device to provide a good quality sound field by selectively eliminating and flattening peak and dip frequencies that make a harsh noise.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of compensating for imperfections in a sound filed, the method comprising determining a frequency-response characteristic of a test signal; extracting a difference spectrum by filtering the frequency-response characteristic on different octave band scales, detecting frequency parameters of peak and dip components that deviate from a critical value in the difference spectrum, and calculating filter coefficients from the frequency parameters to filter an input audio signal.

The extracting of the difference spectrum may comprise subtracting a first spectrum obtained by smoothing a curve representing the frequency-response characteristic on a first octave band scale from a second spectrum obtained by smoothing a curve representing the frequency-response characteristic on a second octave band scale.

The critical value may be set to a minimum peak or minimum dip value perceptible to humans, according to a psycho acoustic model.

The frequency parameters of the peak and dip components may be a Q factor, levels, and a center frequency, the Q factor being obtained by calculating (the center frequency/(an upper cutoff frequency−a lower cutoff frequency)).

The foregoing and /or other aspects and advantages of the present general inventive concept may also be achieved by providing an apparatus to compensate for imperfections in a sound filed, the apparatus comprising an equalizer filter to filter an audio signal using filter coefficients based on frequency parameters of peak and dip components, a sound field measurement unit to determine a frequency-response characteristic of an input test signal, and a filter coefficient extraction unit to selectively detect peak and dip components deviating from a critical value in a curve representing the frequency-response characteristic, according to a psycho acoustic model, and extract from the detected peak and dip components the frequency parameters to be applied to the equalizer filter.

The filter coefficient extraction unit may comprise a first octave band filter to filter the curve of the frequency-response characteristic on a first octave band scale, a second octave band filter to filter the curve of the frequency-response characteristic on a second octave band scale, a subtractor to subtract a first frequency-response characteristic curve resulting from filtering on the first octave band scale from a second frequency-response characteristic curve resulting from filtering on the second octave band scale and to output a different spectrum, and a peak/dip detection unit to detect the frequency parameters of the peak and dip components deviating from the critical value from the different spectrum, according to the psycho acoustic model.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a conventional apparatus for compensating for imperfections in a sound field;

FIG. 2 is a block diagram illustrating an apparatus to compensate for imperfections in a sound field according to an embodiment of the present general inventive concept;

FIG. 3 is a detailed block diagram illustration a filter coefficient extraction unit of FIG. 2;

FIG. 4 is a flowchart illustrating a method of compensating for imperfections in a sound field using peak and dip components, according to another embodiment of the present general inventive concept; and

FIGS. 5A and 5B are graphs illustrating a threshold value with respect to peak/dip components and Q factors, based on a psycho acoustic model.

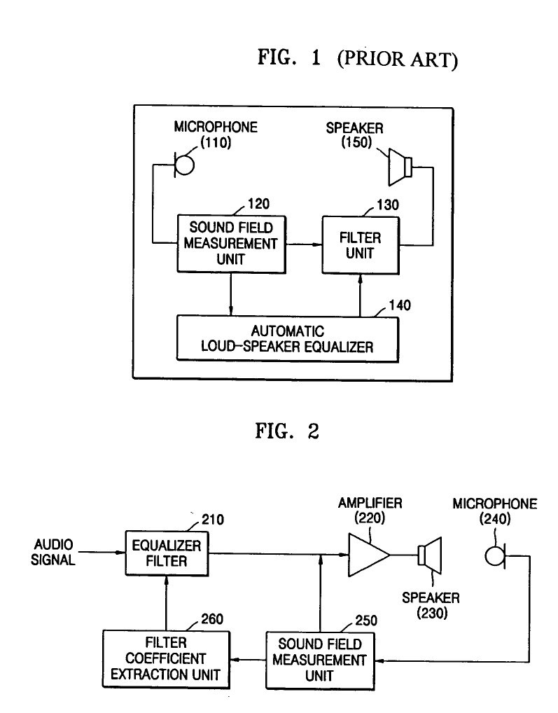

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a block diagram illustrating an apparatus for compensating for imperfections in a sound field according to an embodiment of the present general inventive concept.

The apparatus includes an equalizer filter 210, an amplifier 220, a speaker 230, a microphone 240, a sound field measurement unit 250, and a filter coefficient extraction unit 260.

The microphone 240 converts a test signal or a test sound into an electrical signal. The test signal can be a wideband random noise or a test tone.

The sound field measurement unit 250 determines a frequency-response characteristic using the test signal. For example, the sound field measurement unit 250 obtains an impulse response using the wideband random noise, from which the frequency-response characteristic can be easily derived with a Fast Fourier Transform.

The equalizer filter 210 filters an input audio signal using filter coefficients obtained based on peak and dip frequency parameters (filter parameters).

The filter coefficient extraction unit 260 selectively detects peak and dip frequencies in the frequency-response characteristic determined by the sound field measurement unit 250 that deviate from a critical value, and extracts the filter parameters of the peak and dip frequencies to be applied to the equalizer filter 210. The critical value is set according to a psycho acoustic model.

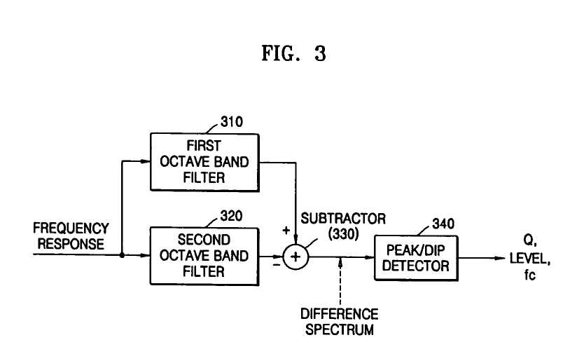

FIG. 3 is a detailed block diagram illustrating the filter coefficient extraction unit 260 of FIG. 2.

Referring to FIG. 3, the filter coefficient extraction includes a first octave band filter 310, a second octave band filter 320, an adder and/or subtractor 330, and a peak/dip detector 340.

The first octave band filter 310 filters a first curve representing the frequency-response characteristic on an octave band scale.

The second octave band filter 320 filters a second curve representing the frequency-response characteristic on an eighth or a sixteenth narrow octave band scale.

The adder and/or subtractor 330 subtracts a first filtered result of the second octave band filter 320 from a second filtered result of the first octave band filter 320 to obtain one or more different spectrums.

The peak and/or dip detector 340 obtains the peak and dip frequency parameters by detecting the peak and dip frequencies having amplitude levels beyond the critical value according to the psycho acoustic model from the difference spectrum.

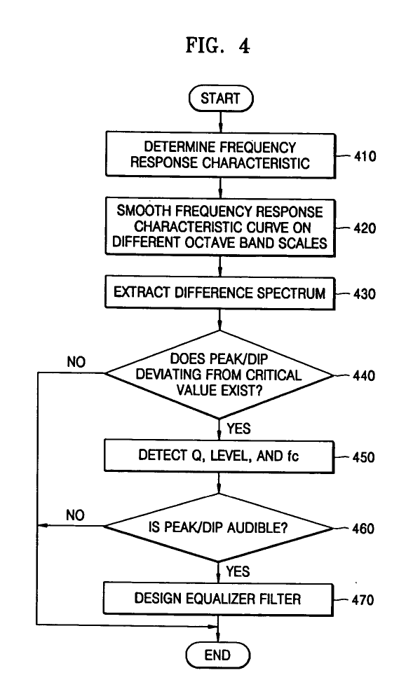

FIG. 4 is a flowchart illustrating a method of compensating for imperfections in a sound field using peak and dip frequencies, according to another embodiment of the present general inventive concept.

Here, the method will now be described in reference with FIGS. 2 and 3.

First, in operation 410, a frequency-response characteristic is determined based on an input wideband noise or a test tone by the sound filed measurement unit 250.

Next, smoothing is performed on the frequency-response characteristic on each of two band scales in operation 420. The smoothing is performed to eliminate fluctuation components so they are not detected as peak and dip components. Also, a result of smoothing the frequency-response characteristic in the octave bands is used as a standard curve to distinguish the peak and/or dip components. The result shows only an average trend of the frequency-response characteristic from which the fluctuation components similar to the peak and dip components are almost eliminated.

In operation 430, a difference spectrum is obtained by subtracting a first frequency-response characteristic obtained by smoothing the frequency-response characteristic on an octave band scale from a second frequency-response characteristic obtained by smoothing the frequency-response characteristic on an eighth or sixteenth narrow octave band scale.

Next, it is determined from the difference spectrum whether an absolute value deviating from a critical value exists in operation 440. In other words, in the difference spectrum, the peak and dip components whose absolute value is over 2 dB are considered to be meaningful. However, the peak and dip components whose absolute value is equal to or less than 2 dB are not discernible to humans.

If it is determined, in operation 440, that a peak or dip component having the absolute value over 2 dB exists, its Q factor, level, and center frequency fc are obtained in operation 450.

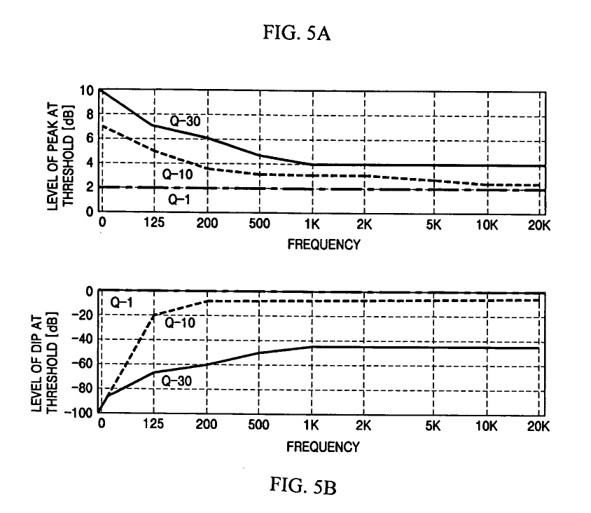

According to a research by Toole and Olive on the psycho acoustic model, the extent to which peak and dip components are perceived by humans depends on their center frequency fc, level, and/or Q factor. The critical level corresponding to a minimum level perceptible to humans can be represented according to the center frequency and Q factor as shown in FIGS. 5A and 5B. An audible critical level can be determined with respect to the peak and dip components according to FIGS. 5A and 5B. The Q factor can be defined by following equation (1):

$$Q = \frac{{f}_{c}}{bw} = \frac{{f}_{c}}{{f}_{u} - {f}_{l}} \qquad ( 1 )$$

Here, fc is the center frequency of each peak or dip frequency, fu is an upper −3 dB cutoff frequency, and f₁ is a lower −3 dB cutoff frequency.

Next, in operation 460, if the level of the detected peak or dip component exceeds the critical level, the level of the peak or dip component is considered to be perceptible to humans, and the center frequency fc and the Q factor of the peak or dip component are stored in a memory. Comparison to the critical value and calculation of the Q factor can be done with respect to the difference spectrum. The gain of a filter is determined according to a difference between a first average level of the frequency-response characteristic obtained by smoothing the frequency-response characteristic on an octave band scale and a second average level of the frequency-response characteristic obtained by smoothing the frequency-response characteristic on an eighth or sixteenth narrow octave band scale.

Finally, the equalizer filter 210 is designed to have the filter coefficients using the stored center frequency fc and Q factor in operation 470. The equalizer filter 210 can use a parametric EQ (equalizer) of an IIR filter or can be another type of a filter having the Q factor and the center frequency fc as its input constants. The equalizer filter 210 is designed to have a center frequency of fc and a bandwidth of fc/Q. The equalizer filter 210 may comprise one filter or a plurality of filters each compensating for a corresponding peak/dip component. As such, among peak and dip components of a system, each degrading acoustic quality can be selectively compensated.

According to the present general inventive concept, as described above, in a sound field compensation filter of an audio system, a center frequency and a bandwidth of an equalizer can be varied, and peak or dip components that lower the sound quality are detected and compensated, thereby enhancing a compensation performance of the audio system.

The method of compensating sound field described above according to the present general inventive concept can be implemented as a computer program. Codes and code segments constituting the computer program may readily be inferred by those skilled in the art. The computer programs may be recorded on computer-readable media and read and executed by computers. Such computer-readable media include all kinds of storage devices, such as ROM, RAM, CD-ROM, magnetic tape, floppy disc, optical data storage devices, etc. The computer readable media also include everything that is realized in the form of carrier waves, e.g., transmission over the Internet. The computer-readable media may be distributed to computer systems connected to a network, and codes on the distributed computer-readable media may be stored and executed in a decentralized fashion.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of compensating for imperfections in a sound field in an audio system, the method comprising:
determining a frequency-response characteristic of a test signal;
extracting a difference spectrum by filtering the frequency-response characteristic on different octave band scales;
detecting one or more frequency parameters of peak and dip components that deviate from a critical value in the difference spectrum; and
calculating filter coefficients from the frequency parameters to filter an input audio signal.

2. The method of claim 1, wherein the extracting of the difference spectrum comprises subtracting a first spectrum obtained by smoothing a first curve representing the frequency-response characteristic on a first octave band scale from a second spectrum obtained by smoothing a second curve of the frequency-response characteristic on a second octave band scale.

3. The method of claim 1, wherein the critical value is set to a minimum peak or minimum dip value perceptible to humans according to a psycho acoustic model.

4. The method of claim 1, wherein the frequency parameters of the peak and dip components are a Q factor, a level, and a center frequency, the Q factor being obtained by calculating a formula of (the center frequency/(an upper cutoff frequency−a lower cutoff frequency)).

5. An apparatus to compensate for imperfections in a sound field in an audio system, comprising:
an equalizer filter to filter an audio signal with filter coefficients based on frequency parameters of peak and dip components;
a sound field measurement unit to determine a frequency-response characteristic of an input test signal; and
a filter coefficient extraction unit to selectively detect the peak and dip components deviating from a critical value in a curve representing the frequency-response characteristic, according to a psycho acoustic model, and to extract from the detected peak and dip components the frequency parameters to be applied to the equalizer filter.

6. The apparatus of claim 5, wherein the filter coefficient extraction unit comprises:
a first octave band filter to filter the frequency-response characteristic on a first octave band scale;
a second octave band filter to filter the frequency-response characteristic on a second octave band scale;
a subtractor to subtract a first curve representing the frequency-response characteristic obtained by filtering the frequency-response characteristic on the first octave band scale from a second curve representing the frequency-response characteristic obtained by filtering the frequency-response characteristic on the second octave band scale, and to output a different spectrum; and
a peak and/or dip detection unit to detect the frequency parameters of the peak and dip components deviating from the critical value from the different spectrum, according to the psycho acoustic model.
